(19) United States
(12) Patent Application Publication
(10) Pub. No.: US 2007/0038533 A1
(43) Pub. Date: Feb. 15, 2007

(54) Equity Distribution System

(76) Inventor: Darren Huff, Groveport, OH (US)

Correspondence Address: NEAL T. HAUSCHILD, 4310 SUNBURY ROAD, GALENA, OH, 43021, US

(21) Appl. No.: 11/161,593

(22) Filed: Aug. 9, 2005

(51) Int. Cl. G06Q 40/00

(52) U.S. Cl. 705/35

(57) ABSTRACT

The present invention relates to a method of creating, purchasing and selling the equity notes based on the appraised value of a real property. A property owner sells, for a certain consideration, equity note to an investor. The compensation paid may be in the form of cash or an equivalent good or service. The equity note has a value which potentially may appreciate over time but will vary depending upon a number of factors including, but not limited to, the value of the property and potential improvements made to the property. The equity note can be sold through securitization or some other method. The option can also become a traded commodity and form the basis for a real estate options and futures market.

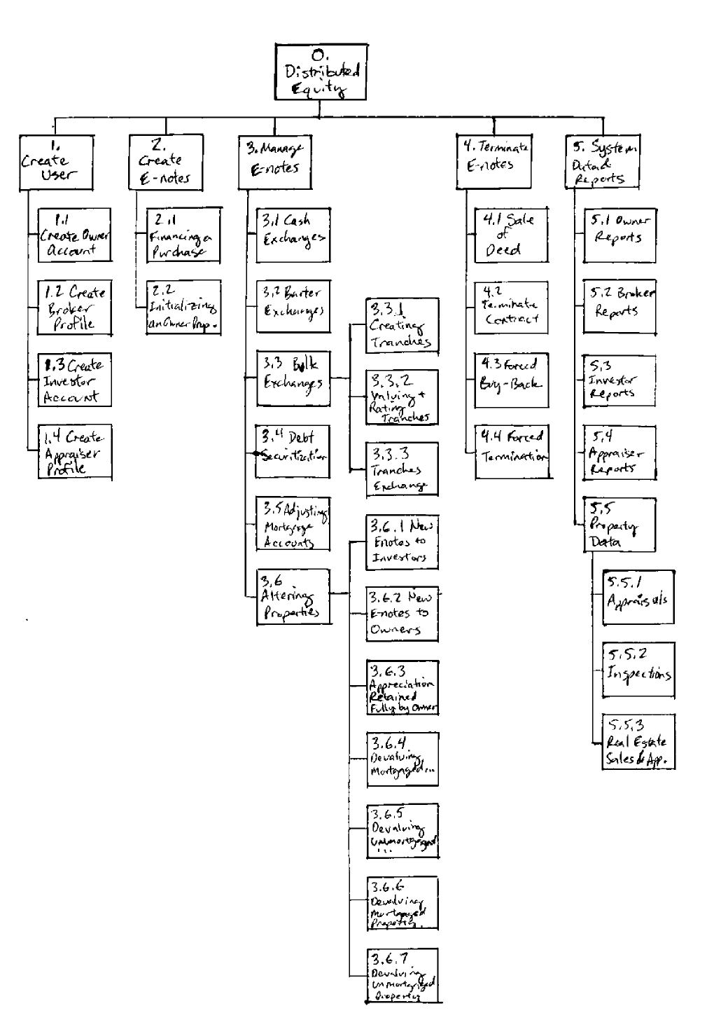

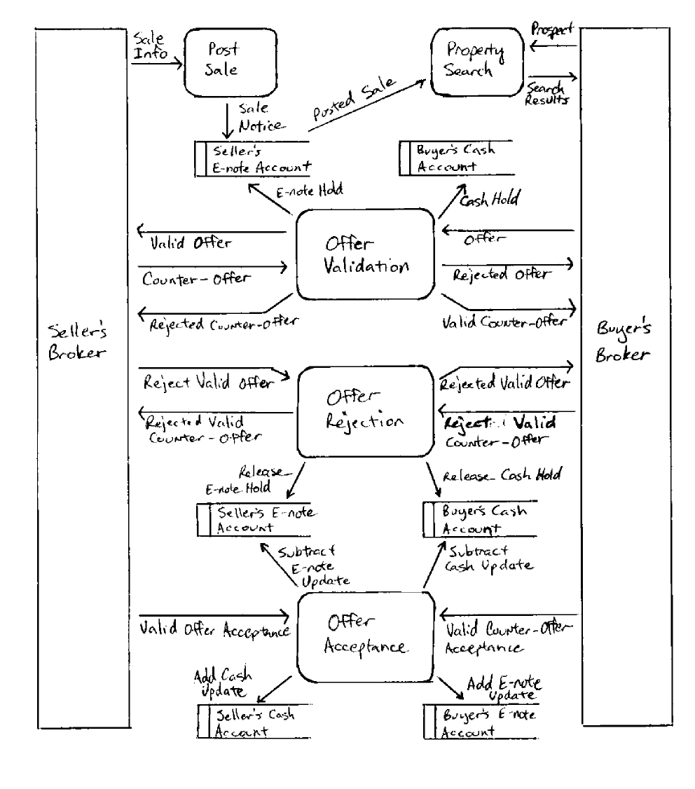

Millions of new and existing homes are sold each year in the United States. The residential mortgage market in itself is a trillion dollar industry. However, once a home is purchased and equity established in the home, there are only a few ways to get cash from the equity in the home: refinancing and applying for a “home equity’ line of credit. Both of these options may have steep closing costs or the owner may incur monthly payments paying back the interest generated from borrowing this money. Increased monthly payments and closing costs prevent many homeowners from being able to have access to the equity in a home, even at attractive mortgage rates. Therefore, the need exists to develop a financial vehicle and method of selling real estate equity that can alleviate some of the burden faced by homeowners and offer another investment option for investors.

During the 1970s, Wall Street developed and popularized new techniques for financing home purchases by providing capital to fund the purchase of residential mortgages. Banks and Savings & Loans were no longer required to fund and hold the hundreds of billions of dollars of mortgages being originated each year. Instead, the securities industry perfected techniques to pool millions of mortgages and sell them in pools to financial investors. Liquidity was injected into the mortgage system, economies of scale were achieved, rates to borrowers decreased as pools spread out risk and made capital more readily available, and a trillion dollar industry emerged. The securities industry acted as the conduit for buying, pooling, and re-selling mortgages.

The benefits of financing mortgages through the pooling of originated loans and selling them in tranches (prioritized, individually priced, and credit-rated segments) to sophisticated investors are now well proven. The real estate market has seen hundreds of billions of dollars in capital become available through securitizing mortgages. The real estate market has been infused with new capital and increased liquidity. As a result, more Americans have been enabled to buy real estate at better interest rates.

In the past 30 years, securitization—the technique of financing cash flows generated from individual or pooled assets such as residential mortgages—has also been used to finance numerous other statistically-predictable cash flows. Examples of such statistically-predictable cash flows include commercial real estate mortgages; oil, power, and telecommunications accounts receivables; cross-border earning remittances; credit card payments; and retail accounts receivables. Securitization enables investors to invest in securities with a calculated risk/reward profile commensurate with their goals and objectives. Rating agencies assess the relative risk profile of each transaction and rate the different tranches of securities, providing various levels of returns for investors. Securitization, as a financing and investor vehicle, has become a trillion dollar business in this country and is gaining popularity overseas. It is the perfect investment tool when historical information is available. Statistical analysis can be used to gauge risk and return, and large volumes of securities can be amassed to achieve economies of scale and lower costs while increasing returns.

Pools of future cash flows can be securitized so long as the cash flows have been engineered to conform to pre-established standards, and investors can statistically determine the payment characteristics of the cash flows so that the various tranches can be sold at rates commensurate with the investment's risk. The aggregation of large pools of cash flows enables statistical analysis by rating agencies and sophisticated investors leading to standardized ratings and buying levels. Commercial properties are also financed using this technique. Even construction and interim loans can be financed using securitization. In today's economy, securitization can be used to finance any cash flow that can be statistically measured by investors who will be able to assign a risk level to the timing and probability of receiving such cash flow.

Since home equity is relatively predictable, it lends itself perfectly to the securitization process. Information on factors such as average time to sell a property, time on the market, median and average property prices, and fair market value are all readily available and can be used by rating agencies, investment bankers, and investors to structure such transactions. As a result, a new process may be developed to serve home owners and investors whereby the right to future real estate equity can be purchased, assigned, sold, and traded.

The equity would be purchased from the natural holder of that right, namely the existing property owner. Moreover, that right can be purchased at any time during the owner's ownership of the property. Moreover, the compensation (i.e. bartering) may take any of a wide variety of forms acceptable to the owner.

Given the predictability of a valid real-time measure of property value, the process of securitization can be used to “monetize” the value of future home equity in the present. In other words, home equity to be earned in the future can be converted to securities with a present-day cash value. The amount of the actual compensation necessary to acquire a particular equity share will vary depending upon factors such as the value of the property at the time the equity share is purchased, the statistically predictable time to resale, and the statistically predictable future value of the acquired equity share, among others; but is ultimately a future cash flow that can be estimated within an acceptable degree of statistical certainty. As such, the equity share lends itself well to the asset-backed securitization process and provides a financial vehicle capable of many benefits including assisting homeowners in tapping into the real property's equity and providing new investment opportunities for investors to diversify their portfolios.

The present invention relates to a process involving the buying and selling of real estate and the equity within real property. Particularly, the invention relates to both a method of securitizing the equity typically associated with appreciation and/or improvements made to real property, and a method for trading equity in real property through the creation of equity notes and a related futures and options market.

Currently, accessing equity in your home can only be done through a mortgage, line of credit or sale of the home, resulting in taking on a monthly expense or loosing the use of the home. Some financial situations leave selling the home as the only result. A new system—distributed equity—could change this predicament and improve the financial lives of many.

In one aspect of the present invention, an investor purchases from a real estate property owner, for a fixed sum, the assignable right to a portion of the value of the real property when the owner decides to sell the property. The compensation paid for the equity notes may be in the form of cash or an equivalent non-cash incentive. The amount of the option premium paid to the owner will vary depending upon a number of factors including, but not limited to the value of the property and the projected appreciation. To ensure that the owner fulfills his obligation to pay the face value of the equity note at the time of sale to the investor, a notarized document may be signed and recorded in public records (e.g., by attachment to the deed of the property) so that no sale of the property could be consummated without the investor being notified and compensated as required by the agreement and managed by an administrative organization.

This invention relates to a system to enable owners of a property to create and manage equity notes (rights to a portion of the sale value of the property in exchangeable form), to facilitate the exchange of equity notes between owners and investors, and to resolve the expiration of equity notes from the system. Equity notes can be created, exchanged and removed from the system. Equity notes and the entire system is run by administrators, but the actual users of the system include real property owners, investors, brokers and appraisers. Owners hold the deed to a piece of real property. Investors purchase, trade or sell equity notes and have equity accounts established. Brokers negotiate buys, sales or trades of equity on behalf of the owner and/or the investor. Appraisers provide the system with information about properties about to be entered into the system or periodically on properties currently in the system. Two accounts are created for each owner—cash account and barter account. Owners or owner's agent/broker can sell or buy equity notes relating only to their property. As properties are added to the system, additional accounts are created for each property. These property accounts are controlled by the owner or owner's agent.

Using an administrative organization to manage the system, an owner of real property puts the value of their real property into the system in the form of equity notes. Owners must retain a portion of the equity notes, and otherwise retain right to sell, occupy, and modify the dwelling. Owners are responsible for taxes, insurance, association dues and maintenance costs. The administrative organization interacts with the owners and investors mainly through licensed independent brokers. The administrative organization provides standardized contracts, appraises properties, records all sales, maintains accounts for investors and owners, and enforces the owner responsibilities.

Home owners and investors would benefit from the present invention since the equity notes would allow them to gain access to a new source of available cash, goods or services and investment opportunities, respectively. Investors will inevitably benefit by creation of the equity notes and the resulting trading of equity notes because investors are always seeking new investment vehicles to diversify their portfolios. Furthermore, securitization of equity notes and the creation of a equity note futures and options market will provide investors with more opportunities and alternatives. Other features and advantages of the present invention will become apparent in the following detailed description.

Reference will now be made in detail to the preferred embodiments of the invention, examples of which are also provided in the following description. Exemplary embodiments of this invention are described in some detail, although it will be apparent to those skilled in the relevant art that some features which are not particularly relevant to the invention may not be shown for the sake of clarity. Although the present invention contemplates a wide variety of applications involving transactions that are facilitated by an administrative organization, the preferred embodiments involve real estate transactions, and more particularly, residential real estate transactions that create a tradable equity commodity. Therefore, the examples provided below are primarily given in the context of equity in a residential property. Nevertheless, it should be obvious that the invention also contemplates commercial real property and non-real property applications.

In the preferred embodiment, a system is created to enable owners of a property to create and manage equity notes which are rights to a portion of the sale value of the property in exchangeable form. To facilitate the exchange of equity notes between owners and investors, and to resolve the expiration of equity notes from the system an administrative organization manages the system.

Equity notes can be created, exchanged and removed from the system, or the purposes of this disclosure, the equity notes discussed and referred to herein is a residential property. However, the present invention is not necessarily so limited. Rather, the property may comprise land and or structures, residential and/or commercial properties. Furthermore, the property need not necessarily be a real property. For example, the principles of the present invention apply equally as well to, for example, business and intellectual property transactions. However, for the purposes of this disclosure, the details of the invention are presented in the context of residential property.

Owners who are contracted with the administrative organization can then submit a specific property into the system. Because of the differences in the nature of primary residences, secondary residences and investment/business property, the administrative organization may have different contracts and rules for each property type. Each property would have a separate entry into the system.

Each entry for each property would require information to be collected about the property, including an appraisal by a licensed appraiser. Information could include but not be limited to: address, picture of property, property description, year built, annual taxes, year home was purchased, purchase price, year sold, sales price, appraisal information, TAV (Total Appraisal Value), license number of the appraiser, bi-annual home condition rating, five-year whole home inspection rating, date entered onto exchange, property id number assigned by administrative organization, REP (Reserved Equity Percentage) and TIV (Total Initial Value).

With a property profile made and property accounts opened, specific individual equity note records need to be created. With an appraisal completed, the equity notes are initiated in denomination as requested by the owner's broker and their total initial value (TIV) would be equal to the total appraisal value (TAV) of the property. Each equity note consists of at least this information: equity note serial number, property ID, initial value (IV), date initiated into system, appraisal value (AV), date of most recent appraisal, last sale date, last sale value (LSV), termination value (TERV), termination date, holders id number. Each equity note has a unique serial number. When equity notes are first created, the holder id number is the owner's ID. Owner IDs shall have distinct characters included so as to be clearly delineable from investor IDs. This will also facilitate database searches if a computer system is used.

Multiple accounts exist for each property to make this equity-trading system complement the mortgage system of property financing. When a property is put into the equity-trading system, the owner acquires additional accounts specific to the property—an equity account, a mortgage equity account for each mortgage company involved and a mortgage cash account for each mortgage company involved. The first account specific to a property is the equity account, listing all equity notes held by the owner for that property.

The owner has a cash account that is specific to the owner but not any properties. When equity notes sell, the proceeds are deposited into the owners cash account and can be drawn upon once the sale is verified by the administrative organization. The mortgage account holds sufficient value of equity notes on a property to cover the principle pay off value of any outstanding mortgages. The owner can place these shares on the exchange, but proceeds from their sale must equal or exceed their proportionate value of the principle balance. Multiple mortgage accounts can exist on each property. Proceeds from the sale of equity notes in the mortgage account are placed in the mortgage cash account of the matching mortgage company and are sent directly to the mortgage company in a timely fashion to be applied toward the principle balance of the loan. Of course, the property owner has the right to decide whether he will sell the property and when he will do so. There need not be an obligation on the property owner to sell the property. However, once the property owner sells the property, the mortgage company and the investors will be informed of the sale and the equity notes shall be redeemed to remove the encumbrances on the property.

In another aspect of the invention, the investors accounts may be assembled so as to allow for equity notes to be placed into a pool with other equity notes for purposes of risk allocation and investment diversification. A pool of equity notes may contain from a specific area such as a particular city, county, state, or region; or the pool may contain equity notes diversified by geographic location, estimated selling price, estimated date of sale, or other factors alone or in combination. Then, pursuant to the principles of securitization, pools of equity notes may be assessed, valued, and sold in tranches to various investors. The tranches will each have to be valued and rated before being issued. Accordingly, the process and advantages of securitization can be applied to the brokerage commission function to provide property purchasers with money today for a service to be rendered in the future. Consequently, property purchasers are served by having some of their burdensome transaction costs defrayed, while the pooling of equity notes along with well-known securitization techniques allows investors to diversify by investing in a new type of security with a predictable risk/reward calculation.

Yet another aspect of the invention involves the creation of a real estate futures and options market. Derivative instruments are created whose value preferably approximates the real estate values underlying the equity notes. The values of these instruments will rise and fall with the values of the associated real estate assets, thereby providing investors with a cost-effective way to invest in the real estate market, real estate owners with the ability to protect their investments, and speculators with the ability to make directional speculations on the value of real estate.

The proposed invention satisfies the needs of a variety of parties. First, home owners are benefited by the creation of a financial vehicle that alleviates some of the financial burden associated with refinancing or sell their property. Equity notes may be purchased at any time during the owner's ownership of the property, but preferably occurs when the real property's value exceeds the amount of money owed on the property or secured against the property. Accordingly, various state real property laws and regulations may need to be satisfied. For example, it may need to be determined whether a given property is owned by multiple owners as joint tenants or tenants-in-common. It may also be necessary to determine whether there is a mortgage holder or lien holder with an interest that must be satisfied.

Equity notes may be purchased as an assignable right. Once again, state property, contract, and other laws and regulations may need to be satisfied. However, purchasing the equity notes as an assignable right provides the investor the opportunity to convey the right to another party, if he so desires. Moreover, the equity notes should be assignable if it is to become a traded commodity.

The distributed equity system transactions may also occur, at least partially, via the internet. Recent years have seen the internet become an increasingly useful facilitator of transactions such as in investing, banking, and mortgage lending. Prospective home buyers, for example, can “go online” to apply for mortgages via the internet through a bank's website. Therefore, the internet can be used to facilitate the exchange of equity notes by, for example, providing property owners with the opportunity to sell equity notes to an investor over the internet, and providing a forum for investors to buy and sell equity notes.

The consideration paid to the property owner in exchange for the right is preferably cash. However, the consideration may take a wide variety of forms. For example, the property owner may be offered compensation related to a credit card, such as a rebate, account credit, or “bonus points” which entitle the account holder to various benefits. In another embodiment of the present invention, the owner may be offered certain designated goods and/or services. Obviously, there are many forms the consideration may take that would be acceptable to the owner. The present invention is not limited to any particular form, type, or amount of compensation. Cash accounts are used in these descriptions to simplify, however barter accounts exist and can be used in much the same way. Barter accounts exist to facilitate the exchange of equity notes even when buyers do not have cash. Barter accounts can hold items with specific assigned values. These items can be goods or services. The account holder creates the item description and sets its exact value. The following steps take an investor through purchasing equity notes using the system, covering offers, counter-offers and cash transfers.

In order to perfect an exchange, cash is deposited in or available in the cash account of the investor. The investor or his designated agent, a broker performs property research using the administrative organization's database. The investor submits an offer for a certain number of equity notes. The system verifies the offer with the broker and forwards it to the owner's broker or the investor's broker upon verification, canceling otherwise. A hold is placed on the cash account in the amount of the offer, canceling if insufficient funds available. The investor's offer is forwarded to the investor's broker for review and processing where it is valid for only the time frame specified in the offer. If counter-offers are made by either the property owner or the investor, the counter-offers or acceptance is verified by the system, canceling counter-offer if unverified or checks value of the counter-offer against available funds in the buyer's cash account, if insufficient it demands remedy from buyer's broker within valid time frame or cancels the whole process. The acceptance of offer or counter-offer is verified by accepter (either the property owner or the investor via their respective brokers. Funds and equity notes are transferred according to the specifications of the deal and the transaction information is updated so that property owners and investors and brokers get accurate reports on activity. This process can also be implemented between two investors that are serving as buyers and sellers of equity notes; the primary difference being that the property owner has the right of first proposal.

The value of the consideration paid to the property owner, or the investor who is selling an equity note, no matter what form that consideration takes, is an amount that would be determined by the purchasing investor. The price to pay for a given equity note will depend on a wide variety of factors including, but not limited to, the value of the underlying property upon which the option is based and the associated risk that an investor anticipates. Those factors which cannot be precisely be calculated can be estimated within a reasonable degree of statistical certainty using data from a wide variety of sources and entered as the property profile. The federal government and most state and local governments collect data regarding property values that is made publicly available. Much of this information is available via the internet through various government internet sites and through private and public organizations' websites. Property value data, for example, can be located for specific properties; local areas such as neighborhoods, cities, and counties; state and regional information showing property values throughout a specific region; and national data showing property values and trends throughout the nation. Such information may also be available from tax records and from various sources that record property sales and associated information. Ample public information is also available regarding average or median holding periods—that is, the time between property sales—for properties in a given area (i.e., local, state, regional, or nationwide), as well as for average and median times that properties listed for sale spend on the market before actually being sold. Many government agencies assemble relevant property-related data including city, county, state, and federal agencies. In addition, other sources such as insurance organizations, non-profit organizations, real estate concerns, and the investment community assemble and make available such data. Therefore, data of varying focus and scope are available from a number of sources. The present invention is not limited to a value analysis that considers only these factors or these sources of information.

Owners may decide to buy equity notes for their property back from investors. The owner deposits cash into the cash account in preparation for the bids and the broker signals to the system that the Right of First Proposal on offers is being invoked. This lasts for a period of time such as 30 days, whereon the system must be signaled again if desired. The time limit prevents properties from being in a perpetual state of buy-back, which would slow down transactions unnecessarily. This invocation forces all offers to buy equity notes pertaining to the property in question to be intercepted by the owner's broker, who sees the deal and has the opportunity to create and forward an offer preceding the intercepted offer. The intercepted offer can then be held for a short amount of time such as three days or forwarded immediately as determined by the owner's broker, but still automatically forwards to the seller's broker once the time expires. If the owner's broker does nothing with the intercepted offer within a short period of time such as three business days, then the original offer automatically is forwarded to the investor holding the equity notes. This helps owners who want to hold equity in their home to have an advantage over other investors when it comes to getting to bid on their own property. E-note sellers can still refuse offers from the owner.

Owners can force a buy-back from investors. It should be noted that the right purchased represents the right to represent the owner of the property when that owner decides to sell the property. There need not be an obligation on the property owner to sell. An owner may sell the equity notes to an investor but retain the property forever. As such the contract between the property owner and the investor via the administrative organization in the preferred embodiment is, in the language of the law, a contract subject to a condition precedent, wherein the condition is the owner's decision to sell the property. The owner must sell the property before any duty to perform arises. If the owner never decides to sell the property, the investors right does not vest and the property owner is under no obligation to compensate the investor. Consequently, there is inherent in the equity note exchange process a risk that the benefit for the investor will never materialize. However, such is the nature of investing and it is reasonable to expect that all investors are keenly aware of the possibility of losing their investment without positive return. There could be a right of forced termination on the part of the investor.

To ensure that the property owner fulfills his obligation to the investor when the property is sold, in the preferred embodiment, a contract is signed by the property owner and the investor prior to being allowed to trade under the distributed equity system. The document, which may be notarized, may be recorded in public records along with the property records such as the title. Local laws may vary with respect to the contents and restrictions of such a document, notarizing requirements, and recordation requirements and procedures. Consequently, applicable local laws should be considered. The equity notes document would then appear in any title search as a cloud on the property title requiring satisfaction before ownership of the property may be validly transferred. As a result, the owner would find it difficult to sell the property without satisfying his obligation under the outstanding equity notes and the contract with the administering organization.

The written agreement that forms the basis of the trading equity notes may take a wide variety of forms, within the parameters of applicable law, and the present invention is not limited to any one specific form of agreement, nor is it limited to any particular choice of language. There are a great many provisions that may be incorporated into the written distributed equity contract. Among the provisions that may optionally be included is a provision governing whether the equity notes transfer with the property in the event the owner bequeaths the property to his heirs instead of selling it (i.e., whether the owner's heirs are bound by the terms of the equity notes and the contract with the administering agency).

Individual equity notes or bundles of notes can be used to secure debts. The administrative organization can secure the debt by creating secured debt equity accounts and secured debtor cash accounts. These allow investors to take equity from various properties and use them to get loans. The institution providing the loans must also be an investor and willing to take the equity notes held in the secured debt equity account in the event of default. A financial instrument that is tradable may be created in addition to the equity note based as an entry in the system.

Investors work with the administrative organization, via their broker to create two accounts, a secured debt equity account and secured debt cash account. Both are specific to the transaction. Sufficient equity is moved into the equity account from the investor's equity accounts. The investor signs a contract with the lending institution agreeing to a lien on specific equity notes or their value in the event of termination. This should be recorded at the court with the number of the accounts on the administrative organization holding the equity notes. Once the paperwork has been recorded, a copy is sent to administrative organization so that the accounts can be frozen. This causes all bid offers to be rejected. The investor is still the owner of these shares but cannot use them in any transactions until the lien in lifted. In the event that equity notes in the secured debt equity account are terminated, i.e. liquidated, the cash is placed in the secured debt cash account.

Once the lien has been fulfilled and copy of the lien cancellation sent to the administrative organization, the equity notes and cash in the two accounts is moved to the investor's respective accounts. Should the investor default on the loan, the administrative organization will follow procedures to ensure that lawful transfer of the equity notes and cash, if applicable, are transferred to the lender's respective accounts.

In the preferred embodiment, the individual equity notes may be collected with other equity notes to produce a pool of equity notes, thereby diversifying the investment and reducing the overall risk. Since the equity note is an option or contractual right on the part of the investor to receive a future cash flow, it is as easily securitized as any other cash generating asset, such as credit card accounts, home equity loans, and mortgages. Securitizing an equity note or pool of equity notes enables the property owner to receive cash in the present for a predicted future cash flow. As such, well-known methods of asset-backed securitization can be applied to the equity note trading system to make it a valuable investment tool.

As with an individual equity note, a pool of equity notes would be valued and analyzed with respect to the risk associated with the investment. The value factors and risk factors associated with individual equity notes also apply to a pool of equity notes overall, however, the analyses may differ. For example, the overall value of a pool of equity notes may be determined by valuing each equity notes within the pool individually, as discussed above. However, in some cases, this approach may not be feasible (for example, with a very large pool of equity notes). Therefore, a pool may be valued on a broader scale. For example, an overall pool value may be determined by considering an average, median, or estimated time between property sales; an average, median, or estimated time that properties spend on the market before being sold; and average, median, or estimated rate of appreciation in property values. Furthermore, the data may be of different scopes. For example, a pool of equity notes may be assembled consisting solely or mostly of equity notes on properties in the state of New York. In such a case, data regarding national averages may be useful; however, New York averages would be particularly useful. A pool of equity notes may also be valued by organizing the equity notes within the pool and using data that is particularly focused on each grouping. For example, equity notes within a pool may be sorted geographically (such as by neighborhood, county, city, state, or region), or chronologically (such as by the date the equity notes is expected to be realized). A pool which contains equity notes from five different states could then be segmented, for value analysis purposes, by state, and data from each state could be applied to the five segments individually to value the entire pool. This approach may be especially useful if the pool contained a large number of equity notes. Obviously, there are a wide variety of ways to efficiently and accurately assess the value of an entire pool of equity notes, and value models will depend on a great number of factors such as their relative sophistication, expense, data available, etc. Some models may also account for expenses such as the costs of rendering brokerage services, transactional costs, and inflationary costs, that yield a net equity notes pool value, rather than a gross value.

Similarly to valuing a pool, the overall risk associated with a pool of equity notes may be determined by assessing the risk of each equity notes within the pool individually, or by relying on broader data sets. For example, a pool may be risk analyzed using the average or median value of the individual equity notes and their underlying properties; the predicted number of equity notes within the pool that will actually be realized; the likelihood that individual equity notes, groups of equity notes within the pool, or the entire pool will be realized; an average, median, or estimated time until equity notes will be realized; and predicted rates of property value appreciation. There are other factors that may also be deemed relevant. Moreover, risk factors can also be calculated by grouping equity notes, such as geographically or chronologically as explained above, and using data that focuses on those particular groupings.

The following details are provided regarding the securitization process, assuming that all applicable laws and regulations have been accounted for and complied with. It should be understood that there are many ways to securitize an asset and the following is provided for exemplary purposes. Moreover, certain details well known in the art that are not crucial to the methods of the present invention may not be mentioned for the sake of clarity.

Generally, the securitization process involves accumulating a pool of equity notes and evaluating their characteristics. The relevant characteristics may include property value and location, type of property, and the information discussed above, such as expected rates of appreciation and associated risk. A pool of equity notes may be evaluated by considering each equity notes individually, or by considering the pool of equity notes as a whole. Moreover, the pool of equity notes as assembled may be organized in a particular way. For example, the pool may consist of equity notes from a particular county. Therefore, the pool could be valued based upon information such as average property values in the county, typical property appreciation within the county, etc.

The party seeking to securitize the equity notes can prepare to offer the securities—the securitized equity notes—to investors. This preparation involves structuring the offering transactions and preparing a prospectus or offering memorandum that details the characteristics of the security in accordance with applicable federal and state securities laws and Securities and Exchange Commission (SEC) regulations. If the options are to be traded on an exchange or commodity market, there may also be rules associated with that forum that would be addressed in the prospectus.

Following the sale of certificates, a trust and servicing agreement, which governs the operation of the trust and the distribution of cash flows to investors, is finalized and the transaction is closed. Investors receive certificates in return for cash investments and the cash gets paid to the party who sold and securitized the equity notes. Once issued, the certificates can be freely traded as with any asset-backed security. The value of the certificates will fluctuate based on the perceived value of the underlying equity notes collateral and based upon general market conditions. For example, a report that national existing home sales increased substantially last month would, presumably, increase the value of the security in investors' eyes.

Equity notes may be traded in a variety of ways. Through the administering organization, equity notes may be traded individually or in pools; or they may be securitized as detailed above. Equity notes, individually or in pools, may be traded such that the equity notes owner has to provide the actual brokerage service when the property owner or owners decide to sell. Alternatively, the equity notes may be traded—much like commodities such as oil—whereby the equity notes continually changes hands but the actual brokerage service is delivered by an entity that is separate from, but perhaps affiliated with, the actual equity notes owner. Equity notes can also form the basis of a real estate futures and options market. For example, derivative instruments and contracts whose values fluctuate based upon the value of individual equity notes or pools of equity notes can be created. These instruments and contracts can then be traded on a commodity exchange, much like well known commodities such as oil.

It will be obvious to anyone skilled in the art that the present invention can be employed in a wide variety of embodiments. The preferred and exemplary embodiments of the invention have been described in some detail, but it will be apparent to those skilled in the relevant art that some features which are not relevant to the invention may not have been described for the sake of clarity. While various embodiments of the present invention have been described above, it should be understood that they have been presented by way of example only, and not limitation. Thus, the breadth and scope of the present invention should not be limited by any of the above-described exemplary embodiments, but should be defined only in accordance with the following claims and their equivalents.

What is claimed is:

1. A method of doing business comprising the steps of:
purchasing from an owner of a real property, in exchange for a consideration, an equity note, wherein said equity note confers the right to a portion of the sale value of the property for an investor; creating a property profile comprising of a total appraised value of the real property, a total initial value of said equity notes, and a reserved equity percentage; establishing a real property account, comprising an equity account, a mortgage equity account, and a mortgage cash account.

2. The method of claim 1 further comprising the step of executing a legally binding document that places an encumbrance on the title of the real property requiring satisfaction of said equity note.

3. The method of claim 1 further comprising the step of determining a current value of said equity notes from the current value of the real property based on an appraisal.

4. The method of claim 1 further comprising the step of selling said equity note.

5. The method of claim 1 further comprising the step of facilitating the buying and selling of said equity notes by a broker.

6. The method of claim 1 wherein the consideration comprises money.

7. The method of claim 1 wherein the consideration is a good or a service.

8. The method of claim 1 wherein an administrative agency manages said equity notes, said property profile, and said property accounts.

9. The method of claim 1 further comprising the step of creating a financial instrument, wherein the value of the instrument varies depending upon the value of the equity note.

10. The method of claim 1 wherein at least a portion of said method is performed using an internet.

11. A method of doing business comprising the steps of:
purchasing from an owner of a real property, in exchange for a consideration, an equity note, wherein said equity note confers a right to a portion of a sale value of the property for an investor; creating a property profile comprising of a total appraised value of the real property, a total initial value of said equity notes, and the reserved equity percentage; establishing a real property account, comprising an equity account, a mortgage equity account, and a mortgage cash account; assessing a risk associated with said right to the portion of the sale value; wherein at least part of one of said steps utilizes a computer.

12. The method of claim 11 further comprising the step of executing a legally binding document that places an encumbrance on a title of the real property requiring satisfaction of said equity note.

13. The method of claim 11 further comprising the step of selling said equity note.

14. The method of claim 11 further comprising the step of determining a current value of said equity notes from the current value of the real property based on an appraisal.

15. The method of claim 11 further comprising the step of facilitating the buying and selling of said equity notes by a broker.

16. The method of claim 11 wherein the consideration comprises money.

17. The method of claim 11 wherein the consideration is a good or a service.

18. The method of claim 11 wherein an administrative agency manages said equity notes, said property profile, and said property accounts.

19. The method of claim 11 wherein the risk associated with said equity note is estimated from at least one of: (a) the estimated value of said equity note, (b) the likelihood that said equity note will be realized, (c) the estimated time until said equity note will be realized, (d) the predicted rate of appreciation in the value of the property, and (e) the possibility that the property will suffer catastrophic damage.

20. The method of claim 10 wherein at least a portion of said method is performed using an internet.
